(19) United States
(12) Patent Application Publication
(10) Pub. No.: US 2009/0079837 A1
(43) Pub. Date: Mar. 26, 2009

(54) IMAGE STABILIZATION FOR IMAGE BASED NAVIGATION SYSTEM

(75) Inventors: Richard Pereira Soares, JR., Fredericksburg, VA (US); Jamal Haque, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/860,069

(22) Filed: Sep. 24, 2007

(51) Int. Cl. H04N 5/225

(52) U.S. Cl. 348/208.99; 348/E05.034

(57) ABSTRACT

Methods and apparatus of stabilizing images used to track an object wherein the images are subject to slurs due to vibrations that are oscillatory in nature is provided. The methods include determining the center of intensity in the images taken of the object and using the center of the intensity to track the object.

### BACKGROUND

Devices that use images for functions that are subject vibrations have to deal with image quality. For example a camera riding on car will experience a vibration due to the motion of vehicle and in result, affect the quality of the image. This vibration between the object of interest and the camera assembly results in image slurs. The slurs hamper the precision of the navigation system. With increased image driven steering systems such as vehicle parking systems, target-tracking systems and automatons docking systems for space aircraft, there is need for removing the vibration caused by the host system.

One method used to deal with image slur due to vibrations is to remove its effect on the image with stabilization techniques that utilize motion estimation and motion correction hardware or algorithms that compensate for the effects of the vibrations. These techniques are necessary for applications that require image clarity such as security system, vehicle detection systems and robotic systems. However, these stabilization techniques consume a relatively large amount of processing resources.

For the reasons stated above and for other reasons stated below which will become apparent to those skilled in the art upon reading and understanding the present specification, there is a need in the art to electronically or digitally stabilize images of the object so that the object can be tracked without requiring a relatively large amount of processing resources.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a method of stabilizing images used to track an object wherein the images are subject to slurs due to vibrations that are oscillatory in nature is provided. The method comprises determining the center of intensity in the images taken of the object and using the center of the intensity to track the object.

### BRIEF DESCRIPTION OF THE DRAWINGS

The present invention can be more easily understood and further advantages and uses thereof more readily apparent, when considered in view of the detailed description and the following figures in which:

FIG. 1 is a device incorporating an image stabilizer of one embodiment of the present invention;

FIG. 2 is a navigation assembly incorporating an image stabilizer of one embodiment of the present invention;

FIG. 3 is a flow diagram of the modes of a navigation system of one embodiment of the present invention;

FIG. 4 is a flow diagram of an image stabilization method of one embodiment of the present invention; and

FIG. 5 is a flow diagram of one method of tracking an object of interest of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an image stabilization method where vibrations are oscillatory in nature and image clarity is not an issue. In embodiments, once an object to be imaged is identified the center of intensity of the object is determined. Using the center of intensity compensates for image slurs cause by the oscillatory vibrations. Hence, embodiments use the fact that slurs caused by the oscillatory vibrations will generally be equal in opposite directions and the center of the object can be identified by the center of intensity. The invention as described below can be used in any application that needs to track an object that is subject to oscillatory vibrations.

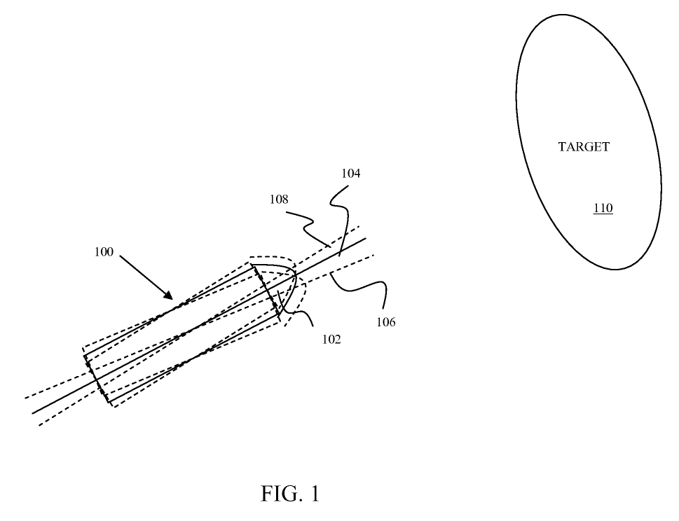

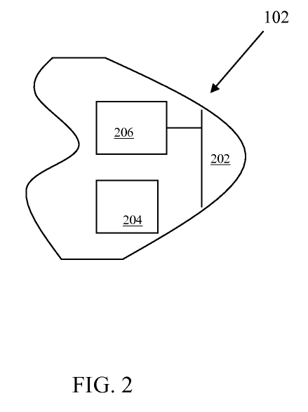

FIG. 1 illustrates a device 100 employing an embodiment of the present invention. The device 100 is directed to track an object of interest 110 with a navigation system 102. As illustrated, the device 100 is subject to oscillatory vibrations which cause images recorded by a camera assembly of the navigation system 102 to have image slurs. In particular, the oscillatory vibrations are illustrated in this example by a correct axis 104 and off axis's 108 and 106. The correct axis 104 illustrates the correct path to the target or object of interest 110. As the device 100 spins about axis 104 it wobbles off (vibrates off) as illustrated by off axis 106 and off axis 108. The wobbling or vibration is oscillatory in as a guidance system 102 of the device 100 will correct itself its path. Part of the guidance system is the navigation system 102. A block diagram of the navigation system 102 of one embodiment is illustrated in FIG. 2. In this example embodiment, the navigation system 102 includes an image recorder 206, an inertial measurement unit (IMU) 204 and a controller 206. The controller 206 processes images recorded by the image recorder 206 and provides control functions of the device 100 based in part on the processed images. The IMU 204 is used to minimize variations in position and velocity which reduces the calculations and time required to align the navigation system 102 with the object of interest.

In one embodiment, a system has three different modes of operation. The first mode is a search mode. In the search mode the controller 206 is processing a relatively large amount of information from images provided by the image recorder since the initial determination of the object of interest is critical. The second mode is a stabilize mode that focus on the center of image intensity. The stabilize mode uses less processing resources than the search mode because it only focuses on identifying the center of intensity of an image. Moreover, since the vibrations the device is subject to are oscillatory in nature, the center of intensity of an image is all that is needed to be determined to track the object of interest. Hence, in embodiments, a stabilize mode can be entered into that requires less processing resources. The third mode is intense mode which like the first search mode uses a relatively large amount of processing resources at the end of a task. Moreover, in a docking example, the intense mode ensures proper alignment as the physical docking takes place.

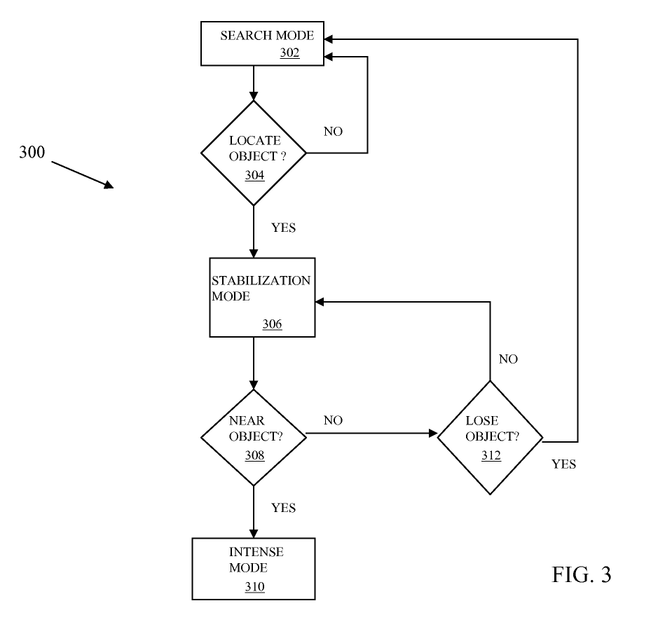

Referring to FIG. 3, a modes flow diagram 300 of a one embodiment is illustrated. As illustrated, the process starts in search mode looking for a target or object of interest (302). As discussed above, in the search mode the processor of the navigation system uses a lot of resources in detecting object of interests since this function is critical. Images taken have to be processed so that the object of interest can be properly identified. The processor during this mode has to deal with image slurs caused by the vibrations. If a valid object of interest is not identified 304, the process continues in search mode (302). If a valid object of interest is identified (304), the navigation system enters into a stabilize mode (306). As discussed above, in the stabilize mode, only the center of intensity of the object of interest is determined for tracking purposes. Hence, processing for tracking the object of interest is substantially reduced. In this embodiment, the process continues by determining if the navigation device is near the object (308). If it is not near the object of interest (308), this embodiment verifies that the target is still being tracked (312). If the object is still being track (312), the navigation system remains in stabilization mode at (306). If the object is no longer being tracked (312), search mode is reestablished at (302). If it is determined that the navigation system is near the object of interest (308), an intense mode is entered into in which increased processing resources are needed.

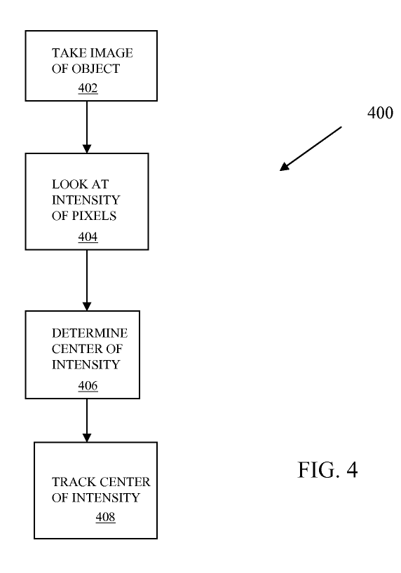

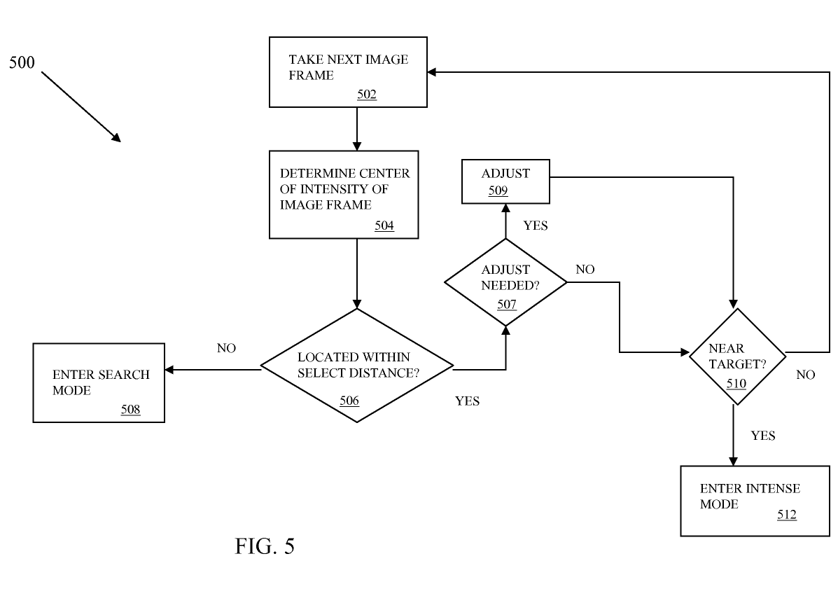

FIG. 4 is a stabilize mode flow diagram 400 of one embodiment utilized by a device of the present invention. As illustrated, an image of the object of interest is taken (402). The image is then processed by determining the intensity of the pixels of the image (404). The center of intensity of the pixels is then determined (406). The center of intensity in sequential image frames are then tracked (408). FIG. 5 is a tracking flow diagram 500 of one embodiment. In this embodiment, a next image frame is taken (502). The center of intensity of the next image frame is then determined (504). The distance of the center of intensity of the then current image frame from the center of intensity of the previous image frame is determined. If the distance is outside a predetermined distance (506), the navigation system enters back into the search mode (508). If the distance is within the select distance (506), it is determined is the travel direction of the navigation system needs to be adjusted (507). Hence, in this embodiment, the distance between pixels of subsequent image frames is tracked to determine if the object of interest is still being tracked and the path of the navigation system has to be adjusted. For example, if the distance of the pixel count is more than N pixels away (506), a first distance, you would enter into search mode to reacquire the target (508). If however, the distance between pixels that make up the center of intensity in subsequent frames is only M pixels away (506) (where M is less than N), then you may want to adjust the travel direction of the navigation system (509). In the embodiment of FIG. 5, once it is determined that either no adjustment is needed (507) or once a needed adjustment is made (509), it is determined if you are near the object of interest (510). If you are near the object of interest (510), an intense mode is entered into at (512). If, however, you are not near the object of interest (510), the process continues by taking the next image frame at (502).

The methods and techniques used by the controller as described above can be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although, the above embodiments, have been described as applying to a navigation system of a docking system it can be applied to any type of apparatus used to track an object where the apparatus or object is subject to vibrations that are oscillatory in nature. Such systems may include but are not limited to image driven steering systems such as vehicle parking systems, security systems, vehicle detection systems and robotic systems. Hence, the present invention is not limited to navigation systems.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of stabilizing images used to track an object wherein the images are subject to slurs due to vibrations that are oscillatory in nature, the method comprising:
determining the center of intensity in the images taken of the object; and
using the center of the intensity to track the object.

2. The method of claim 1, wherein determining the center of intensity further comprises:
determining the intensity of pixels in the images; and
finding the most intense pixels of the image.

3. The method of claim 2, wherein using the center of intensity to track the object further comprises:
determining the distance between pixels that make up the center of intensity in consecutive image frames; and
based on the distance, adjusting the device tracking the object.

4. The method of claim 2, further comprising:
when the distance between pixels that make up the center of intensity in consecutive image frames is greater than a select distance, changing the mode used to track the object.

5. The method of claim 4, wherein changing the mode used to track the object further comprises,
changing the mode to a search mode to re-establish the tracking of the object.

6. The method of claim 5, wherein the search mode includes object identification using all information in the images including information as the result of slurs.

7. A method of tracking an object of interest with a navigation system subject to oscillatory in nature vibrations, the method comprising:
using a search mode to locate the object of interest; and
once the object of interest is located, using a stabilization mode that uses less processing recourses than the search mode, the stabilization mode further using the center of intensity of images to track the object of interest.

8. The method of claim 7, wherein determining the center of intensity further comprises:
determining the intensity of pixels in an image; and
determining the pixels of the highest intensity.

9. The method of claim 7, wherein the search modes further comprises:
processing object of interest identification algorithms of the images;
processing aim point algorithms; and
processing guidance algorithms.

10. The method claim 7, wherein tracking the image in stabilization mode further comprises:
comparing the location of the center of intensity in concurrent image frames of the object of interest; and
when the distance between the center of location in concurrent image frames is beyond a first defined limit, adjusting the travel path of the navigation system.

11. The method of claim 10, further comprising:
when the distance between the center of location in concurrent image frame is beyond a second defined limit, switching back to the search mode to re-establish tracking of the object of interest.

12. The method of claim 7, further comprising:
entering a intense processing mode when the navigation system is within a predefined distance to the object of interest.

13. A device using images subject to slurs from oscillatory vibrations, the device comprising:
a navigation system including,
an image recorder, and
a controller configured to determines the center of image intensity for tracking purposes in images recorded by the image recorder in a reduced processor resources stabilize mode.

14. The device of claim 13, wherein the controller is further configured to use a search mode to identify the object of interest.

15. The device of claim 13, wherein the controller is further configured to enter into an intense processing mode when the navigation system in near the object of interest that requires more processor resources than is required in the stabilize mode.

16. The device of claim 13, wherein further comprising:
an inertial measurement unit in communication with the controller to minimize variations in position and velocity.

17. The device of claim 13, wherein the controller in determining the center of intensity in the stabilization mode is configured to determine the intensity of pixels in an image and determine the pixels of the highest intensity.

18. The device of claim 13, wherein the controller in tracking the object of interest in stabilization mode is configured to compare locations of the center of intensity in subsequent image frames of the object of interest and when the distance between the center of location in subsequent images is beyond a first defined limit, adjusting the travel path of the navigation system.

19. The device of claim 13, wherein the controller is further configured to enter into a search mode when the distance between the center of location in subsequent images is beyond a second defined limit to re-establish tracking of the object of interest.
